(19) United States
(12) Patent Application Publication
(10) Pub. No.: US 2024/0356807 A1
(43) Pub. Date: Oct. 24, 2024

(54) AUTOMATING A CONFIGURATION OF AN INFRASTRUCTURE FOR CLOUD APPLICATIONS

(71) Applicant: International Business Machines Corporation, Armonk, NY (US)

(72) Inventors: Srikumar Venugopal, Dublin (IE); Christian Pinto, Dublin (IE); Michele Gazzetti, Dublin (IE); Alessandro Pomponio, Dublin (IE)

(21) Appl. No.: 18/304,535

(22) Filed: Apr. 21, 2023

(51) Int. Cl. H04L 41/08; H04L 41/0894; H04L 41/16

(52) U.S. Cl. CPC H04L 41/0886; H04L 41/0894; H04L 41/16

(57) ABSTRACT

Embodiments of the present invention provide an approach for automating a configuration of a server infrastructure for cloud applications by leveraging monitoring data from both the infrastructure and the applications that run on it. Specially, input information including an application which has been submitted is received along with a target dataset, a cloud provider and values for a specific performance measure. The application is mapped to a specific class and a performance model is selected based on the class. A set of resource configurations is generated and estimates of a target measure (e.g., run time) are provided for each configuration option using the selected model. A resource configuration option that provides either the best value of the measure or closest to the application objectives is selected and committed to an application deployment file.

### TECHNICAL FIELD

The present invention relates to managing configuration options for cloud environments, and more specifically to embodiments for automating a configuration of a server infrastructure for cloud applications by leveraging monitoring data from both the infrastructure and the applications that run on it.

### BACKGROUND

Enterprises have been increasingly deploying their distributed applications on clouds, which include public clouds, private clouds, hybrid clouds, and so forth. Cloud computing is the on-demand availability of computer system resources, especially data storage and computing power, without direct active management by a user. Large clouds often have functions distributed over multiple locations, each of which is a data center. A cloud can include resources that tenants of the cloud can use to implement an application.

### SUMMARY

Embodiments of the present invention provide an approach for automating a configuration of a server infrastructure for cloud applications by leveraging monitoring data from both the infrastructure and the applications that run on it. Specially, input information including an application which has been submitted is received along with a target dataset, a cloud provider and values for a specific performance measure. The application is mapped to a specific class and a performance model is selected based on the class. A set of resource configurations is generated and estimates of a target measure (e.g., run time) are provided for each configuration option using the selected model. A resource configuration option that provides either the best value of the measure or closest to the application objectives is selected and committed to an application deployment file.

A first aspect of the present invention provides a method for automating a configuration of a server infrastructure for cloud applications, comprising: obtaining, by a processor, input information including an application and a set of attributes related to the application; automatically mapping, by the processor, the application to a class based on the set of attributes; selecting, by the processor, a performance model based on the class; generating, by the processor, a set of resource configuration options based on a target measure for each resource configuration option that is calculated using the selected performance model; selecting, by the processor, a resource configuration option from among the generated set of resource configuration options, wherein the calculated target measure of the selected resource configuration option is closest to an application objective; and applying, by the processor, the selected resource configuration option to an application deployment file.

A second aspect of the present invention provides a computing system for automating a configuration of a server infrastructure for cloud applications, comprising: a processor; a memory device coupled to the processor; and a computer readable storage device coupled to the processor, wherein the storage device contains program code executable by the processor via the memory device to implement a method, the method comprising: obtaining, by a processor, input information including an application and a set of attributes related to the application; automatically mapping, by the processor, the application to a class based on the set of attributes; selecting, by the processor, a performance model based on the class; generating, by the processor, a set of resource configuration options based on a target measure for each resource configuration option that is calculated using the selected performance model; selecting, by the processor, a resource configuration option from among the generated set of resource configuration options, wherein the calculated target measure of the selected resource configuration option is closest to an application objective; and applying, by the processor, the selected resource configuration option to an application deployment file.

A third aspect of the present invention provides a computer program product for automating a configuration of a server infrastructure for cloud applications, the computer program product comprising a computer readable storage device, and program instructions stored on the computer readable storage device, to: obtain, by a processor, input information including an application and a set of attributes related to the application; automatically map, by the processor, the application to a class based on the set of attributes; select, by the processor, a performance model based on the class; generate, by the processor, a set of resource configuration options based on a target measure for each resource configuration option that is calculated using the selected performance model; select, by the processor, a resource configuration option from among the generated set of resource configuration options, wherein the calculated target measure of the selected resource configuration option is closest to an application objective; and apply, by the processor, the selected resource configuration option to an application deployment file.

### BRIEF DESCRIPTION OF THE DRAWINGS

FIG. 1 depicts a block diagram 100 illustrating an example of an environment for the execution of at least some of the computer code involved in performing the inventive methods, in accordance with embodiments of the present invention.

FIG. 2 depicts a block diagram 200 of a system architecture involved in performing the inventive methods, in accordance with embodiments of the present invention.

FIG. 3 depicts a more detailed diagram 300 of a system architecture involved in performing the inventive methods, in accordance with embodiments of the present invention.

FIG. 4 depicts a flow diagram 400 of one or more components of a system environment by which services provided by one or more components of an embodiment system may be offered as cloud services, in accordance with an embodiment of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

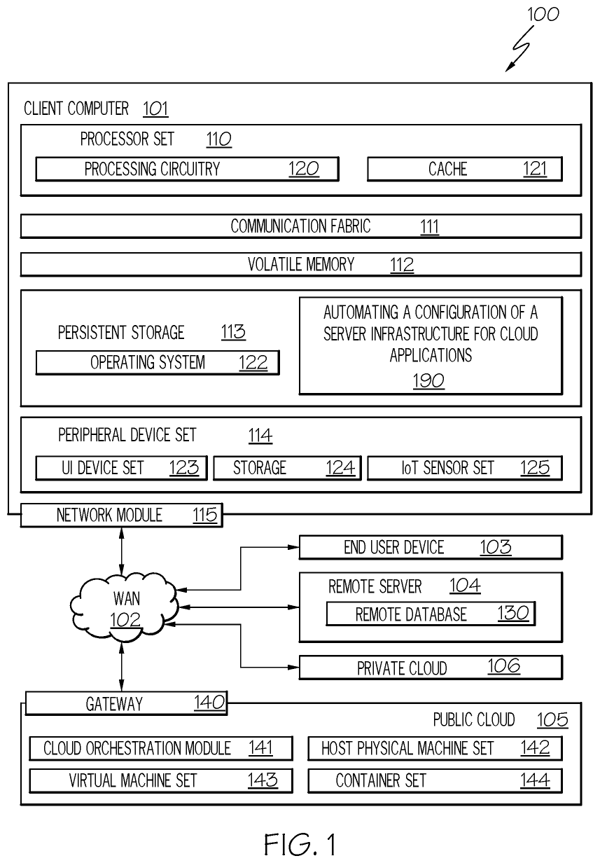

Computing environment 100 of FIG. 1 contains an example of an environment for the execution of at least some of the computer code involved in performing the inventive methods, such as automating a configuration of a server infrastructure for cloud applications 190. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Managing deployment of an application across multiple cloud environments can be challenging. An “application” can refer to a workload, a service, or any collection of tasks. A “cloud environment” (or more simply, a “cloud”) can refer to a collection of resources and services that a tenant (a user, an enterprise, a machine, a program, etc.) can use for deploying an application. A cloud environment can include a computing platform or multiple computing platforms, where a “computing platform” can refer to a collection of resources, including any or some combination of processing resources, storage resources, network resources, virtual resources, database resources, programs, and so forth. Different cloud environments can be provided by different cloud providers, which are entities that manage and offer respective resources of corresponding cloud environments for use by tenants of the cloud environments. A cloud environment can include a public cloud (which is available over a public network such as the Internet to tenants), a private cloud (which is available to a particular group of tenants), a hybrid cloud (which includes a mixture of different clouds), and so forth.

Assigning and configuring the right resources to workloads is not an easy task. Over-allocation of resources can quickly inflate infrastructure costs. Under-allocation can translate in quality of service (QOS) violations and poor user experience. Administrators and developers working on both cloud and on-premises (or “on-prem”) infrastructures need considerable effort to fine-tune both aspects of resource utilization and application performance. The problem increases in complexity when the vast catalog of infrastructure options and class of applications supported in both cloud and on-prem environments is considered. Moreover, emerging technologies supporting composable resources will allow Infrastructure provider to size server nodes resources based on workload requirements. This relaxes resource allocation constraints, opens new opportunities for better resource management but it also expands the range of possible infrastructure configurations available. Previous efforts attempt to tackle certain aspects of resource configuration based on workload performance and requirements.

The proposed mechanism produces a configuration for applications being deployed to a cluster or cloud provider guided by models/mechanisms trained on performance data of past executions. This configuration includes, but is not limited to, attributes such as number of compute nodes, compute cores, and memory per machine. An application is automatically mapped to a class determined based on attributes including, but not limited to, application framework, datasets and workload, and where the class is used to identify an appropriate performance model for estimating a performance of a candidate configuration, and for training post application execution. The proposed mechanism may interface with a computing infrastructure to create a cluster by combining on-demand physical resources such as compute cores, memory banks and accelerators based on the configuration produced. The proposed mechanism may further manage a library of models for predicting application performance measures (e.g., execution time, throughput) and/or infrastructure measures (e.g., utilization), and retrain a correct set of models.

As stated, embodiments of the present invention provide an approach for automating a configuration of a server infrastructure for cloud applications by leveraging monitoring data from both the infrastructure and the applications that run on it. Specially, input information including an application which has been submitted is received along with a target dataset, a cloud provider and values for a specific performance measure. The application is mapped to a specific class and a performance model is selected based on the class. A set of resource configuration are generated and estimates of a target measure (e.g., run time) are provided for each configuration option using the selected model. A resource configuration option that provides either the best value of the measure or closest to the application objectives is selected and committed to an application deployment file.

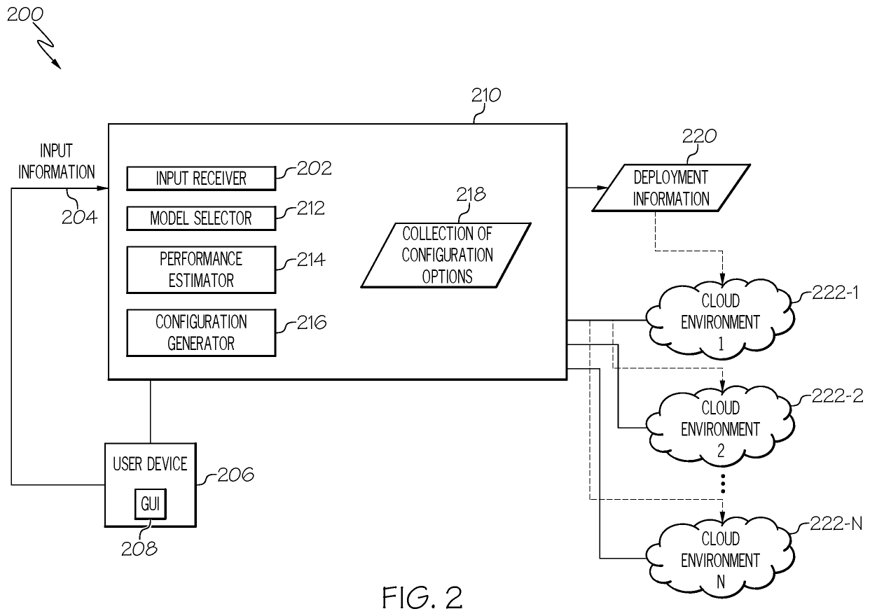

FIG. 2 depicts a block diagram 200 of an arrangement that includes a cloud infrastructure configuration (CIC) engine, according to some examples. In accordance with some embodiments, a CIC engine is able to go beyond previous attempts by modeling both QoS requirements and infrastructure resource configuration to deliver a best execution environment to informing applications. The CIC engine receives, through a user interface, input information relating to an application (e.g., in a generic declarative form) that can flexibly be used with different types of applications and/or cloud environments of different cloud providers. The input information can be received from a user (such as an application administrator or other user) or another entity.

A “cloud provider” can refer to an entity that manages a cloud and that offers resources and services that are accessible by tenants of the cloud. A tenant can refer to a human user, an enterprise (e.g., a business concern, a government agency, an educational organization, etc.), a machine, or a program (that includes machine-readable instructions).

The input information can specify components of the application and performance and operational specifications for the application or each component of the application. For example, the input information can include an application to be run (e.g., a Spark-based workload, a TensorFlow training job, etc.), a target performance metric (e.g., execution run time, throughput, mean request serving time, etc.), a provider of infrastructure resources on which the application will run (e.g., a composable system, a cloud provider, or an existing cluster), and/or the like. A computer cluster is a set of computers that work together so that they can be viewed as a single system. The computer clustering approach typically connects a number of readily available computing nodes (e.g. personal computers used as servers) via a fast local area network. The activities of the computing nodes are orchestrated by “clustering middleware”, a software layer that sits atop the nodes and allows the users to treat the cluster as by and large one cohesive computing unit, e.g. via a single system image concept.

The CIC engine leverages historical data/information collected by both the infrastructure and by previous application runs to perform three functions. First, the CIC engine is configured to classify each application depending on its resource usage profile (e.g., CPU utilization over the whole application life, memory utilization, accelerator utilization, network resource management, etc.). Application resource utilization primarily identifies the key factors that impact the response times and throughput of applications. CPU utilization is the percentage of time the processor spends doing work as opposed to being idle. Memory utilization is measured as a percentage of physical memory utilized when the application is running. Accelerator utilization and network resource management can also be included as factors to be considered. An accelerator is a hardware device or a software program with a main function of enhancing the overall performance of the computer. Also, network resource management is the process of managing and allocating resources for networking processes. Resources can be assigned differently depending on the amount of network traffic that is being processed. The factors above are illustrative only and not intended to be limiting. Other factors can be considered when classifying an application.

Second, the CIC engine is configured to train models that estimate resource utilization and performance metrics of application classes. Training a model simply means learning (determining) good values for all the weights and the bias from labeled examples. In supervised learning, a machine learning algorithm builds a model by examining many examples and attempting to find a model that minimizes loss; this process is called empirical risk minimization. Loss is the penalty for a bad prediction. That is, loss is a number indicating how bad the model's prediction was on a single example. If the model's prediction is perfect, the loss is zero; otherwise, the loss is greater. The goal of training a model is to find a set of weights and biases that have low loss, on average, across all examples. Using tools like Watson®, the CIC engine can learn (using a machine learning model) to estimate resource utilization and performance metrics of application classes. (Watson is a trademark of International Business Machines in the U.S. and/or other countries).

Third, the CIC engine is configured to train a metamodel to choose the best models for the estimation outlined above based on the application being submitted. The metamodel is a model that is used to perform model selection which includes selecting one or more models to use among various candidates on the basis of performance criterion. In the context of learning, this may be the selection of one or more models from a set of candidate models, given data. In the simplest cases, a pre-existing set of data is considered. However, the task can also involve the design of experiments such that the data collected is well-suited to the problem of model selection. Given candidate models of similar predictive or explanatory power, the simplest models can most likely be the best choices (Occam's razor). However, any techniques, now known or later discovered, can be utilized when performing model selection.

Upon the submission of a new application, the CIC engine will identify a class the application belongs to and use this information to select the most appropriate models to generate multiple resource configuration options (also referred to as “deployment plans” and estimate performance metrics for the application class. The system will generate candidates for the resource configuration and use models for obtaining performance estimations. The CIC engine selects, based on a desired value of a performance metric, the configuration that produces the closest estimate to that value. The configuration is translated into a set of resource requests for the application. In some embodiments, the configuration is submitted to a composable system to create a cluster with desired characteristics. After deployment of the application using the selected configuration option, the CIC engine is able to adjust an allocation of resources to the application responsive to performance metrics from a performance monitor that monitors performance of the application after the deployment.

As used here, an “engine” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, an “engine” can refer to a combination of a hardware processing circuit and machine-readable instructions (software and/or firmware) executable on the hardware processing circuit.

As shown in FIG. 2, the cloud infrastructure configuration engine 210 includes an input receiver 202 that receives input information 204. In some examples, the input information 204 is received from a user device 206, which can include a desktop computer, a notebook computer, a tablet computer, a smartphone, or any other type of electronic device that a user can by used to access CIC engine 210. The user device 206 can be coupled to the CIC engine 210 over a network, such as the Internet, a local area network (LAN), a wide area network (WAN), a wireless network, and so forth.

The user device 206 has or is coupled to a display device to display a graphical user interface (GUI) 208, which allows a user of the user device 206 to enter information to produce the input information 204. In other examples, the input information 204 can be provided by another entity, such as a machine or program. As stated, input information 204 can include components of an application and performance and operational specifications for the application or each component of the application.

For example, the input information 204 can include an application design part and a performance-operational specification part. The application design part can define the components of the application, configuration specific details of the components, and how the components are linked to one another, as well as other information. The performance-operational specification part can include information specifying a target performance level (or multiple target performance levels) of the application, and/or an operational specification (e.g., the application or a certain component of the application is to be deployed on a certain type of cloud environment). The input information 204 can be in the form of a text document. In other examples, the input information 204 can be in other formats, such as a markup language format (e.g., extensible Markup Language or “XML”), and/or the like.

As shown in FIG. 2, CIC engine 210 may be provided by one or more modules, such as model selector 212, performance estimator 214, and configuration generator 216. The CIC engine 210 automatically maps an application to a class determined based on the attributes including but not limited to application framework, datasets and workload, wherein the class is used to identify an appropriate model for estimating the performance of a candidate configuration, and for training post application execution. More specifically, performance estimator 214 is configured to estimate performance metrics for the application class. Configuration generator 216 is configured to generate a collection of resource configuration options 218 and use models for obtaining performance estimations. In some examples, the configuration generator 216 can communicate with the user device 206 and can cause the collection of configuration options 108 to be presented in the GUI 208 of the user device 206. Presenting the configuration options 218 to the user of the user device 206 allows the user to select or rank the configuration options. In other examples, the configuration options 218 are not presented to the user. Instead, the configuration generator 216 is able to select one of the configuration options based on a desired value of a performance metric (i.e., the configuration that produces the closest estimate to that value).

More generally, the configuration generator 216 is able to select a configuration option from the collection of configuration options 218, based on user input and/or the target goal. For the selected configuration option, the configuration generator 216 outputs deployment information 220, which can be in the form of configuration files for configuring resources of multiple cloud environments 222-1, 222-2, and 222-N.

In some examples, the CIC engine 210 also includes a performance monitor, which can monitor performance of the application deployed on the resources of the cloud environments 222-1 to 222-N. Based on the monitored performance, the performance monitor can provide performance metrics to the configuration generator 216. Based on performance metrics provided by the performance monitor, the configuration generator 216 can adjust an allocation of resources of a cloud environment (or multiple cloud environments) for the application.

The input receiver 202, the model selector 212, the performance estimator 214, the configuration generator 216 and (in some cases) the performance monitor can each be implemented as a portion of the hardware processing circuit of the CIC engine 210. Alternatively, the model selector 212, the performance estimator 214, the configuration generator 216 and (in some cases) the performance monitor can be implemented as machine-readable instructions executable on the CIC engine 210. Alternatively, the performance monitor can include respective monitoring agents executing in the respective cloud environments 222-1 to 222-N.

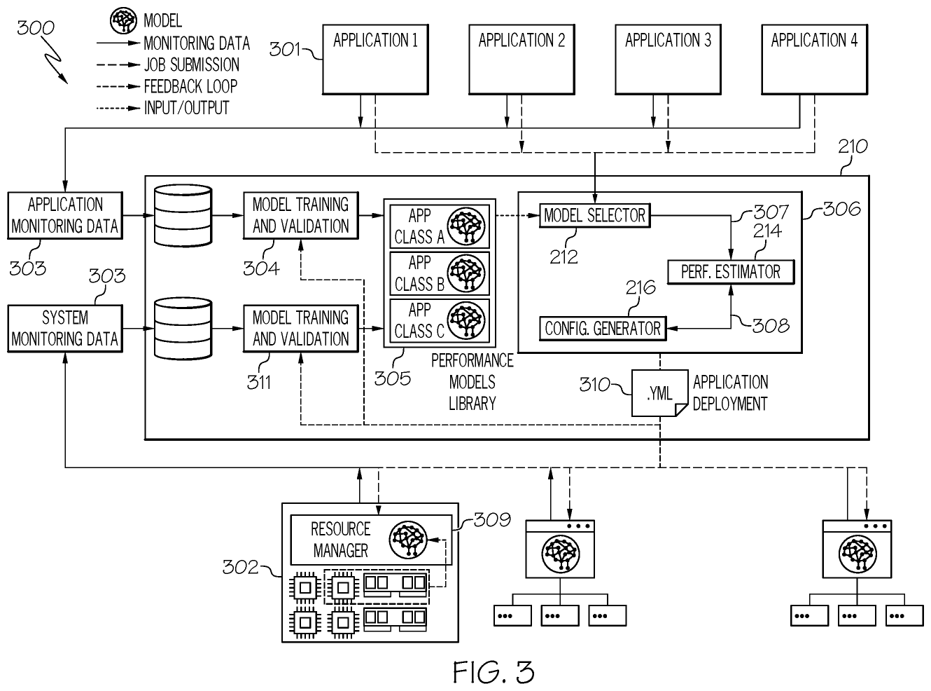

FIG. 3 depicts a more detailed architecture 300 for automating a configuration of a server infrastructure for cloud applications by leveraging monitoring data from both the infrastructure and the applications that run on it. At 301, a CIC engine accepts a variety of applications including data analytics (e.g., Spark SQL), machine learning (TensorFlow), etc. In information technology, an application (app), an application program, or application software is a computer program designed to perform an activity. Depending on the activity for which it was designed, an application can manipulate text, numbers, audio, graphics, and a combination of these elements. Some applications focus on a single task, such as word processing, while others, called integrated software, include several applications. Applications can be grouped into classes based on workload descriptors, frameworks, input datasets, utilization of resources, and/or the like.

At 302, the CIC engine targets a variety of cloud infrastructures from different providers. The output of the system can either be a full cluster deployment running an orchestration framework (e.g., Kubernetes/OpenShift) or provide resource limits and requests for applications deployed on existing clusters. In some embodiments, the CIC engine is configured to provision resources in composable systems, where physical hardware such as compute cores, memory, and/or accelerators can be combined on-demand in a service-oriented fashion. In composable infrastructure, compute, storage, and networking resources are abstracted from their physical locations and can be managed by software through a web-based interface. A resource manager allocates resources to different applications and follows a model to guide its decisions. A resource manager is software that manages resources in a network. Different clusters have different resource managers guided by different models (e.g., an infrastructure model).

At 303, data from an application's execution is stored and retrieved. Similarly, monitoring data from an infrastructure is collected and retrieved. At 304, historical application data is used to train performance models for different application classes. A performance model is an analytical model used to predict various performance metrics such as speedup of search request response time, number of computers needed for optimal search times, and/or the like. Monitoring data and/or historical application data can be stored in one or more databases. According to various exemplary embodiments of the present invention, a database can be any database structure as is known and understood by those skilled in the art. The databases discussed herein can be, for example, any sort of organized collection of data in digital form. Databases can include the database structure as well as the computer programs that provides database services to other computer programs or computers, as defined by the client-server model, and any computer dedicated to running such computer programs (i.e., a database server).

A training model is a dataset that is used to train a machine learning (ML) algorithm. It consists of the sample output data and the corresponding sets of input data that have an influence on the output. The training model is used to run the input data through the algorithm to correlate the processed output against the sample output. The result from this correlation is used to modify the model. This iterative process is called “model fitting”. The accuracy of the training dataset or the validation dataset is critical for the precision of the model. Model training in machine language is the process of feeding an ML algorithm with data to help identify and learn good values for all attributes involved. There are several types of machine learning models, of which the most common ones are supervised and unsupervised learning. Supervised learning is possible when the training data contains both the input and output values. Each set of data that has the inputs and the expected output is called a supervisory signal. The training is done based on the deviation of the processed result from the documented result when the inputs are fed into the model. Unsupervised learning involves determining patterns in the data. Additional data is then used to fit patterns or clusters. This is also an iterative process that improves the accuracy based on the correlation to the expected patterns or clusters. There is no reference output dataset in this method.

To that end, historical infrastructure monitoring data is used to train infrastructure models for resource management. A performance model takes input parameters such as resource configuration (e.g., number of nodes, compute cores and memory per node, etc.) and provides an estimate of one or more measures such as execution run time, throughput, and/or the like. Models may be developed using different methods such as statistical (e.g., random forests, k-means, etc.), reinforcement learning, or neural networks, among others. An infrastructure model takes input parameters such as resource configuration to provide an estimate of system measures such as utilization.

At 305, performance models are stored and catalogued in a model library and are served through a framework (e.g., KServe, etc.). The performance models can be stored in one or more databases. At 306, an application is submitted to the system with a target dataset, a cloud provider and values for specific performance measure. It may not specify a resource configuration initially. The model selector 212 maps the application to a specific class and selects a performance model from the library pertaining to that class, at 307. The configuration generator 216 provides a set of configurations to the performance estimator 214, at 308. The latter provides estimates of a target measure (e.g., run time) using the selected model. The configuration that provides either the best value of the measure or closest to the application objectives, is committed to the application deployment file. The configuration generator 216 could also look up a table of tested configurations. If the target is a composable system or a cloud provider, the configuration specifies attributes such as number of nodes, compute cores and memory size. If the target is an existing cluster, then the configuration is translated to resource requests and limits.

At 309, when the target cloud provider is a composable system, the configuration is also used to generate a cluster with the specified resource configuration. At 310, the chosen configuration is applied to the application deployment file and the application is submitted to the target cluster. After the application execution is over, the logs are gathered and stored, at 311. If there is a drift between model prediction and actual performance measure, the models are retrained and validated using the logs of the most recent executions. Model drift is the decay of models' predictive power as a result of the changes in real world environments. It is caused due to a variety of reasons including changes in the digital environment and ensuing changes in relationship between variables.

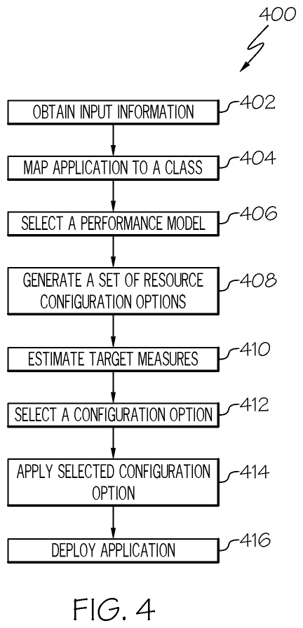

FIG. 4 depicts a flow diagram 400 for automating a configuration of a server infrastructure for cloud applications by leveraging monitoring data from both the infrastructure and the applications that run on it. At 402, the CIC engine 210 obtains input information including an application which has been submitted to the system with a target dataset, a cloud provider and values for a specific performance measure. It may not specify a resource configuration initially. At 404, the CIC engine 210 maps the application to a specific class and selects a performance model from the library pertaining to that class. At 406, the CIC engine 210 generates a set of configurations and provides, at 408, estimates of a target measure (e.g., run time) for each configuration option using the selected model. At 410, a configuration option that provides either the best value of the measure or closest to the application objectives is selected and committed to an application deployment file. Alternatively, the CIC engine 210 can look up a table of tested configurations. If the target is a composable system or a cloud provider, the selected configuration option specifies attributes such as number of nodes, compute cores and memory size. If the target is an existing cluster, then the selected configuration option is translated to resource requests and limits. When the target cloud provider is a composable system, the selected configuration option is also used to generate a cluster with the specified resource configuration. At 414, the chosen configuration is applied to the application deployment file and the application is deployed (or submitted) to the target cluster, at 416. After the application execution is over, any execution logs are gathered and stored in a repository/database. If there is a drift between model prediction and actual performance measure, the models that were used can be retrained and validated using the logs of the most recent executions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for automating a configuration of a server infrastructure for cloud applications, comprising:
obtaining, by a processor, input information including an application and a set of attributes related to the application;
automatically mapping, by the processor, the application to a class based on the set of attributes;
selecting, by the processor, a performance model based on the class;
generating, by the processor, a set of resource configuration options based on a target measure for each resource configuration option that is calculated using the selected performance model;
selecting, by the processor, a resource configuration option from among the generated set of resource configuration options, wherein the calculated target measure of the selected resource configuration option is closest to an application objective; and
applying, by the processor, the selected resource configuration option to an application deployment file.

2. The method of claim 1, further comprising deploying, by the processor, the application to a target server.

3. The method of claim 2, further comprising generating, by the processor, the resource configuration option for the application to be deployed guided by a model trained on performance data of past executions.

4. The method of claim 3, wherein the resource configuration option includes at least one of a number of compute nodes, compute cores, and memory per machine.

5. The method of claim 1, further comprising automatically mapping, by the processor, the application to a class based on attributes including at least one of an application framework, datasets and workload.

6. The method of claim 1, further comprising interfacing, by the processor, with a computing infrastructure to create a cluster based on the selected resource configuration option.

7. The method of claim 1, further comprising managing, by the processor, a library of performance models for predicting application performance measures and retraining a subset of the performance models when a model prediction deviates from at least one target measure by a value over a predefined threshold.

8. A computing system for automating a configuration of a server infrastructure for cloud applications, comprising:
a processor;
a memory device coupled to the processor; and
a computer readable storage device coupled to the processor, wherein the storage device contains program code executable by the processor via the memory device to implement a method, the method comprising:
obtaining, by a processor, input information including an application and a set of attributes related to the application;
automatically mapping, by the processor, the application to a class based on the set of attributes;
selecting, by the processor, a performance model based on the class;
generating, by the processor, a set of resource configuration options based on a target measure for each resource configuration option that is calculated using the selected performance model;
selecting, by the processor, a resource configuration option from among the generated set of resource configuration options, wherein the calculated target measure of the selected resource configuration option is closest to an application objective; and
applying, by the processor, the selected resource configuration option to an application deployment file.

9. The computing system of claim 8, further comprising deploying, by the processor, the application to a target server.

10. The computing system of claim 9, further comprising generating, by the processor, the resource configuration option for the application to be deployed guided by a model trained on performance data of past executions.

11. The computing system of claim 10, wherein the resource configuration option includes at least one of a number of compute nodes, compute cores, and memory per machine.

12. The computing system of claim 8, further comprising automatically mapping, by the processor, the application to a class based on attributes including at least one of an application framework, datasets and workload.

13. The computing system of claim 8, further comprising interfacing, by the processor, with a computing infrastructure to create a cluster based on the selected resource configuration option.

14. The computing system of claim 8, further comprising managing, by the processor, a library of performance models for predicting application performance measures and retraining a subset of the performance models when a model prediction deviates from at least one target measure by a value over a predefined threshold.

15. A computer program product for automating a configuration of a server infrastructure for cloud applications, the computer program product comprising a computer readable storage device, and program instructions stored on the computer readable storage device, to:
obtain, by a processor, input information including an application and a set of attributes related to the application;
automatically map, by the processor, the application to a class based on the set of attributes;
select, by the processor, a performance model based on the class;
generate, by the processor, a set of resource configuration options based on a target measure for each resource configuration option that is calculated using the selected performance model;
select, by the processor, a resource configuration option from among the generated set of resource configuration options, wherein the calculated target measure of the selected resource configuration option is closest to an application objective; and
apply, by the processor, the selected resource configuration option to an application deployment file.

16. The computer program product of claim 15, further comprising program instructions stored on the computer readable storage device to deploy, by the processor, the application to a target server.

17. The computer program product of claim 16, further comprising program instructions stored on the computer readable storage device to generate, by the processor, the resource configuration option for the application to be deployed guided by a model trained on performance data of past executions.

18. The computer program product of claim 17, wherein the resource configuration option includes at least one of a number of compute nodes, compute cores, and memory per machine.

19. The computer program product of claim 15, further comprising program instructions stored on the computer readable storage device to automatically map, by the processor, the application to a class based on attributes including at least one of an application framework, datasets and workload.

20. The computer program product of claim 15, further comprising program instructions stored on the computer readable storage device to interface, by the processor, with a computing infrastructure to create a cluster based on the selected resource configuration option.
